(19) United States
(12) Patent Application Publication
(10) Pub. No.: US 2021/0114406 A1
(43) Pub. Date: Apr. 22, 2021

(54) Shock-Tolerant Omni Wheel

(71) Applicant: CrossWing Inc., Aurora (CA)

(72) Inventors: Stephen SUTHERLAND, Aurora (CA); Philippe GUILLAUMONT, Oakville (CA); Daniel SUTHERLAND, Aurora (CA)

(21) Appl. No.: 17/137,215

(22) Filed: Dec. 29, 2020

Related U.S. Application Data
(63) Continuation of application No. PCT/CA2020/050688, filed on May 21, 2020.

(30) Foreign Application Priority Data
May 21, 2019 (CA) 3043879

(51) Int. Cl. B60B 19/12; B60B 19/00

(52) U.S. Cl. CPC B60B 19/12; B60B 19/003

(57) ABSTRACT

An omni-wheel according to the present invention has a continuous axle and roller design enabling robust durability and ease of manufacturing. The omni-wheel hub is designed to be injection moldable in two halves which constrain the continuous axle or be 3D printed as one piece with integral rollers and continuous axle which controllably deform to reduce vibration and under sudden physical shock, deform to protect structural integrity.

### CROSS-REFERENCE TO RELATED APPLICATIONS

The present application is a continuation of PCT Application No. PCT/CA2020/050688 filed May 21, 2020, which claims priority from Canadian Application No. filed May 21, 2019, both incorporated herein by reference in their entireties.

### TECHNICAL FIELD

The present application refers to omni-directional wheels or omni-wheels and, in particular, to omni-wheels designed for mobile robots, robotic platforms, wheelchairs or other vehicles, including autonomous vehicles of all sizes, desiring holonomic motion.

### BACKGROUND

Omni-wheels are advantageous over regular wheels in that they enable motion in all directions, much like casters, with the added benefit that if powered or braked, force in one direction, typically perpendicular to their central hub, can be regulated. This is achieved when free-wheeling rollers mounted at a ninety-degree angle to the wheel hub replace traditional tires around the wheel's outer circumference. Roller segments all rotate about individual axles (or are sometimes grouped in sets of rollers rotating about multiple axles) around the circumference of the wheel. Under heavy loads or when subject to shock forces, these individual axles and their supporting structures can relatively easily fail, often in a catastrophic failure of one or more rollers as axels permanently bend or fracture; since unlike traditional simple wheel and spoke designs where a continuous rim of the wheel surrounds and connects all spokes emanating from the wheel hub, these omni-wheel designs locate the independent roller axles and supporting structures outside of the continuous wheel rim and thus load bearing portion of these designs are no longer structurally integral and tied to a continuous rim, but instead consists of multiple independent axles. Without continuity of the rim around the spokes radiating straight out from the wheel hub, these independent roller axles reduce performance of the omni-wheels non-uniformly such that larger load capacity and larger diameter omni-wheels have not been found to be robust to sudden shock forces. A new type of omni-wheel is needed to limit this non-uniform reduction in performance and also enable larger vehicles to employ holonomic motion.

A popular approach to strengthen omni-wheels has been to use large diameter roller axles (relative to the outer roller diameter) secured in enlarged supporting structures protruding from the hub of the wheel. One limitation with this approach is that the relatively small difference in the circumference of the rollers and the relatively large supporting structures fails to enable the omni-wheel to perform property on soft surfaces including carpets where the rollers sink into the surface and fail to support the load above the axle support structures. Thus, the axle support structures do not clear the surface and the resulting friction defeats the rollers ability to enable the omni-wheel to efficiently move in all directions. Attempts to mitigate friction from the support structure often involves either the mounting of two separate omni-wheels beside each other in a slightly offset manner so that each support structure has a roller of the other wheel immediately adjacent or, in a similar, but more tightly combined structure where such additional rollers sit beside each axle support structure of the first set of rollers and in turn have their supports beside the first set of rollers. But this mitigation strategy is only partially effective and in many cases, the rollers become deeply embedded within the support structure, offering large pockets where dust and debris can become embedded, restricting the performance of the axle. Another limitation of enlarged support structures is complexity of assembly and the increased mass of the wheel and related increased material costs.

The lack of robustness to sudden shock forces have also contributed to the fact that omni-wheels have typically been used for many years in mobile robotic applications designed to operate on flat, relatively planar or consistent surfaces such as a pedestrian walkway, roadway, shopping mall or other applications. Included in these generally flat support surfaces are gravel or dirt roads, carpeted surfaces in homes and expansive flat surfaces such as used in airports, malls, warehouses and other similar applications. With applications of this type, the requirement for an extensive suspension system is often unnecessary and the wheel hubs can operate on fixed axles or simplified axle support arrangements.

Some limited degree of absorbing movement of the axle itself can be used to improve performance and to reduce unnecessary movement of an electronic head or sensor portion of the robot. Visual and proximity sensors in particular may be sensitive to undampened sudden movement. Generally, flat surfaces reduce these issues but are still prone to disruption from time to time—for example, at the transition point when a robot moves from a tiled kitchen floor to a hallway carpet or hardwood floor.

Omni wheels are capable of rolling in different directions to allow improved turning and driving of the related vehicle or robotic structure. Overdriving one wheel can cause other wheels to react to this drive and rotate as necessary. For many applications, three or four independently driven omni-wheels are provided each at a similar or identical angle to the adjacent omni-wheels allowing the robotic structure to move essentially in any direction to achieve true holonomic motion.

Omni wheels have a plurality of rollers spaced about the periphery of the wheel with each roller rotatable about an axis transvers to a main axis of the wheel. The wheel is capable of moving in a first direction with rotation of the wheel about the main axis and/or movement in a transverse direction due to rotation of the rollers in contact with the ground. The omni wheel typically has a series of separate rollers provided around the periphery of the wheel with each of these rollers supported on its own axle adjacent the periphery of the wheel. The separation between adjacent rollers is reduced as much as possible, however, each of these axles are supported at the end of the rollers (or intermediate the length thereof) and a spacing gap occurs between adjacent rollers.

Such a spacing gap, in the case of a single omni-wheel, represents a small vacant section where the wheel circumference has an effectively smaller diameter and thus the hub will slightly drop as it rotates through such vacant section with the lowest point of the hub at the point where it is supported by opposed edges of two adjacent rollers. A large spacing gap between the rollers causes an even larger undesirable change in the movement of the platform as these void portions between adjacent rollers must periodically traverse the support surface causing an up and down motion of the hub over time which often introduces cyclic rocking of the structure above, depending on direction of travel relative to the omni-wheel orientation. To reduce this disadvantage, some omni-wheels include different roller segments consisting of three or more rollers on one share axle with opposed end segments being conical in nature and the center sections being more cylindrical in nature. The end conical sections provide a transition in the otherwise varying diameter of the wheel. Also, the conical end sections allow the roller axle to be longer in length and often with fewer rollers, reducing total component counts. Spoke support portions near opposite ends of the roller axles provide support and can incur substantial stress under high shock loads. Such focused stress over time can lead to shorten life expectancy, more maintenance issues or unexpected failure of the spoke or axles.

It is possible to increase the size of the spoke portions to thereby increase spoke strength and decrease the possibility of failure, however, this type of solution necessitates that the space between adjacent rollers is increased. Such increase in space between rollers decreases the consistency in the rolling contact of the wheel.

The present invention provides a structure which has been found to be an effective combination allowing good strength and shock tolerance, ease of manufacturing and maintenance, as well as good rolling contact of the wheel with a support surface.

### SUMMARY

An omni-wheel according to the present invention has a continuous axle and roller design enabling robust durability and ease of manufacturing. The omni-wheel hub is designed to be injection moldable in two halves which constrain the continuous axle or be 3D printed as one piece with integral rollers and continuous axle which controllably deform to reduce vibration and under sudden physical shock, deform to protect structural integrity.

### DESCRIPTION OF DRAWINGS

Preferred embodiments of the invention are shown in the drawings, wherein:

FIG. 1 is a perspective view of the omni-wheel;

FIG. 2 is a front view of the omni-wheel;

FIG. 3 is an end view of the omni-wheel;

FIG. 4 is an exploded perspective view showing various components used in the assembly of the omni-wheel;

FIG. 5 is a cross-section through the omni-wheel showing a continuous support used to support the individual roller wheels;

FIG. 6 is perspective view showing the omni-wheel hub with the various radially extending ribs used to support the individual roller wheels;

FIG. 7 is a front view and FIG. 7A is a rear view of the left hand component of the omni-wheel hub;

FIG. 8 is a front view and FIG. 8A is a rear of the corresponding right hand member of the omni-wheel hub;

FIG. 9 is an assembled view of the roller;

FIG. 10 is an exploded view of the components of each roller wheel;

FIG. 11 is perspective view showing the smoothly curved continuous support that supports the individual roller wheels;

FIG. 11A shows a portion of the continuous support appropriately displaced to allow insertion of rollers wheels thereon;

FIG. 11B is a sectional view through the continuous support showing the engagement of the continuous support with each roller wheel;

FIG. 11C is a sectional view of the continuous support;

FIG. 11D is a sectional profile view of a rib end (after assembly of the two halves of the hub) showing the port or socket through which the continuous support runs and also showing one end of the wheel cell;

FIG. 12 is a front perspective of two omni-wheel secured to each other and offset to accommodate gaps between individual roller wheel;

FIG. 13 is a front view of the double omni-wheel of FIG. 12; and

FIG. 14 is an end view of the double omni-wheel.

### DETAILED DESCRIPTION

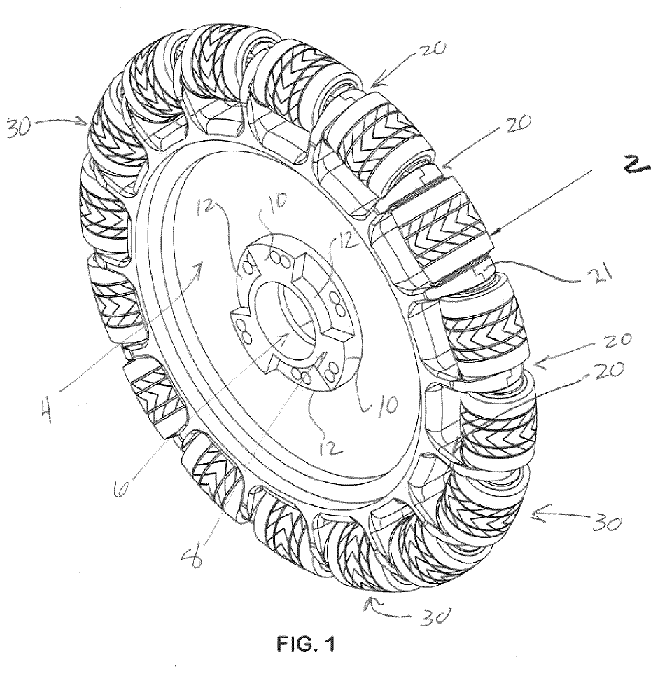

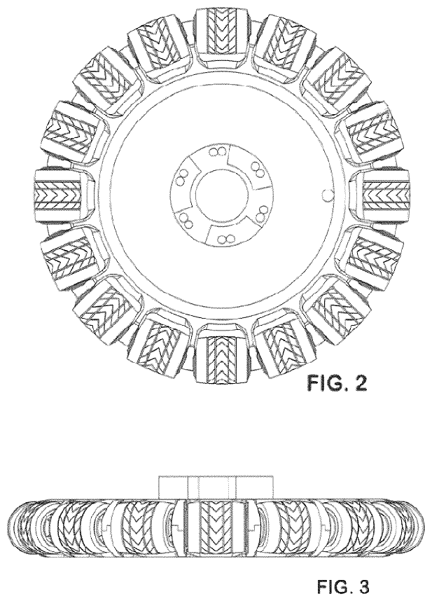

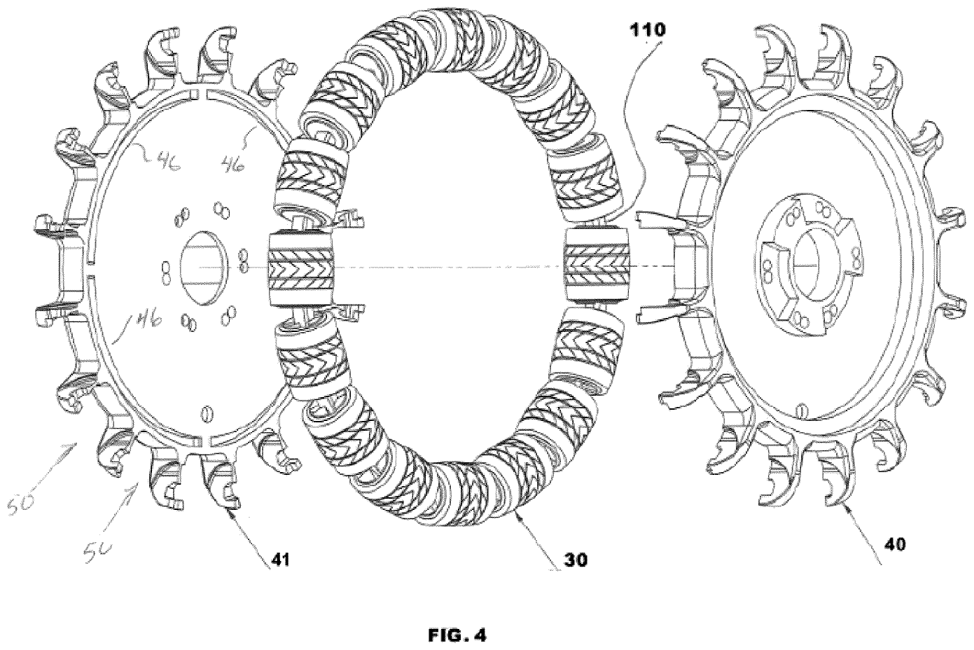

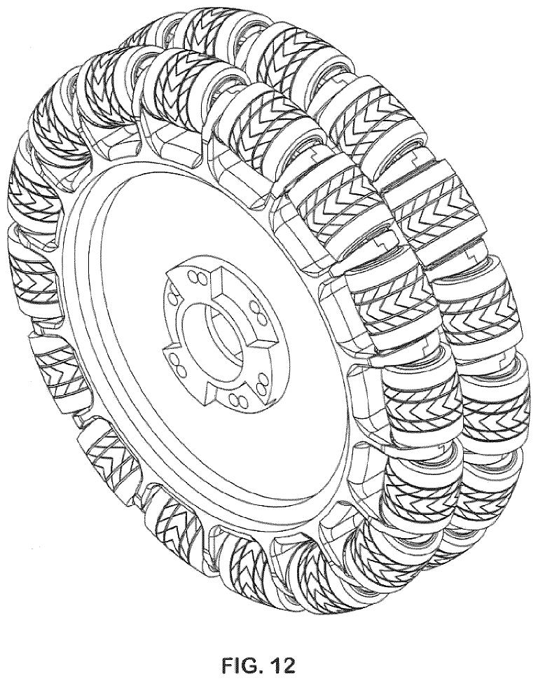

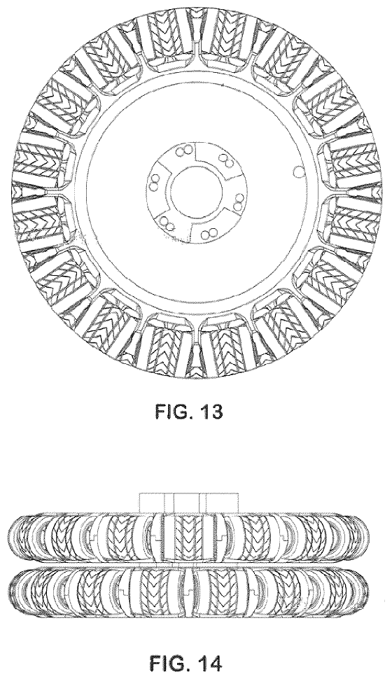

The omni-wheel 2 shown in FIG. 1 includes the central hub 4 supporting the series of individual rollers wheels 30. The central hub 4 includes an axle port 6 and the axle bearing 8 around the axle port. The axle bearing includes wheel locking lugs 10 and wheel locking recesses 12 that are used with respect to a double omni-wheel structure shown in FIGS. 12, 13 and 14. The series of roller wheels 30 are supported on a continuous central support 110 shown in FIG. 4. The continuous central support 110 is supported by the series of radially extending ribs 20 which extend outwardly from and are part of the central hub 4.

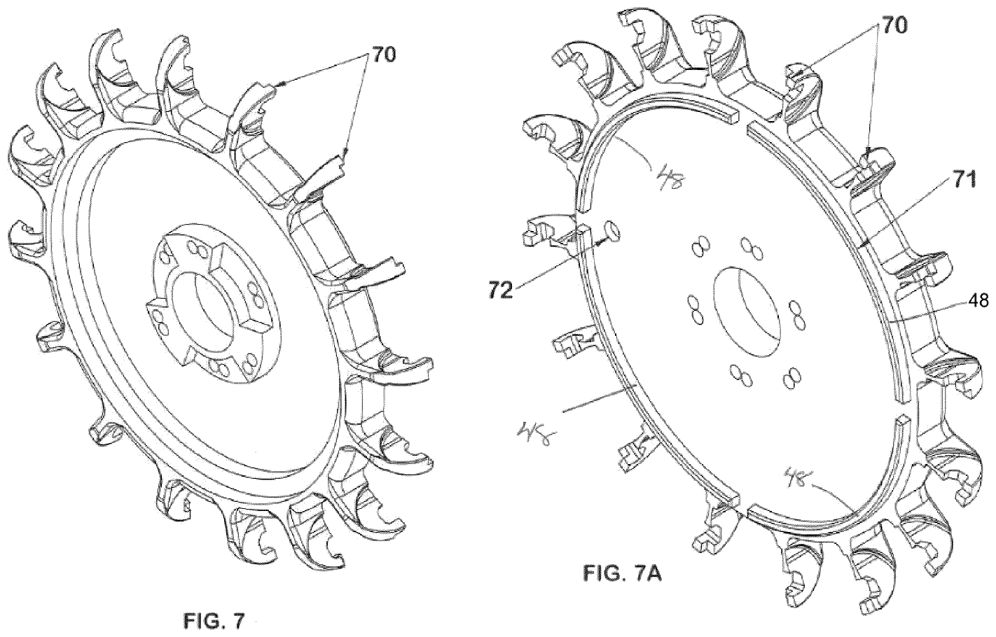

The central hub 4, as shown in FIG. 4, includes the right hub section 40 and the left hub section 41. The hub 4 is generally vertically split through the radially extending ribs 20 to define these two overlapping components. The left hub section 41 includes alignment recesses 46 that cooperate with alignment ribs 48 shown in FIG. 7 that are part of the right hub section. The alignment recesses and the alignment ribs simplify alignment of the left and right hub sections and alignment of the radially extending ribs. Note that the ribs have a notched overlapping connection 21 which alternate in a left and right overlapping pattern.

The series of radially extending ribs 20 are spaced one from the other to define wheel cells 50 of a length to receive an individual roller wheel 30 within the wheel cell. Preferably, the thickness of the radially extending ribs increases from the interior edge of the rib to the outer peripheral edge of the rib. The increase in width adds strength and maintains the position of the roller wheel on the continuous support 110. The inner dimension of the wheel cell generally determines the maximum length of the roller wheel as it requires room for rotation.

The roller wheels have rotating cylindrical portions that define the inner spacing. As the ribs extend radially outwardly, there is a bigger gap and the ribs preferably increase in width. As will be more fully described with respect to each roller assembly 90 of the roller wheels 30, the sleeve portion 100 with collar segments 92 and 94, engage the ribs and sleeve portion need not rotate relative to the ribs. Each roller wheel includes a bearing portion 101 which rotates on sleeve portion 100 supported by the continuous support 110 and held in position along such continuous support by being sandwiched between adjacent ribs.

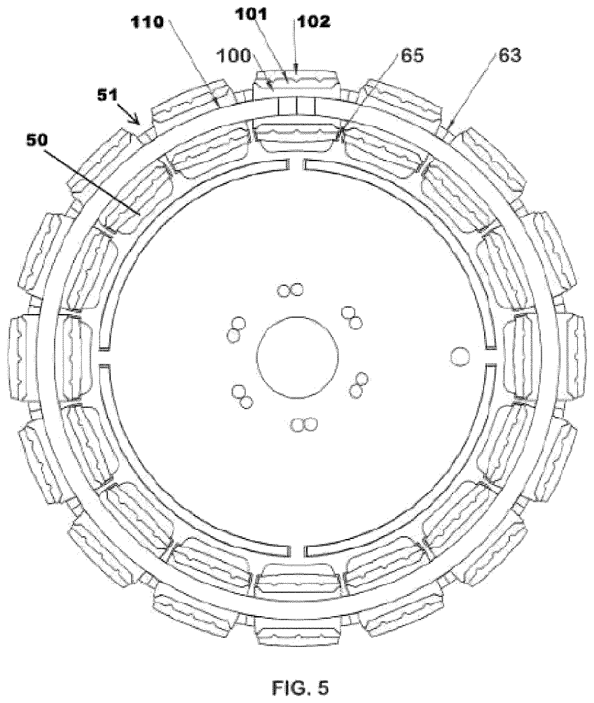

With this arrangement, a minimum spacing between each roller wheel is provided such that the peripheral gap between roller wheels is reduced. This gap, shown as 51 in FIG. 5, defines a flat portion between the two roller wheels and will affect the smoothness of the rolling of the omni-wheel. Furthermore, this gap can be prone to receiving foreign objects which again affects the rolling characteristics of the wheel and thus the sides of roller wheels 30 are tapered outwards (as can be seen in 51) to leverage centrifugal force to expel contaminants as the omni-wheel rotates. Maintaining the gap between adjacent rollers small and not relying on direct rotation at the ribs, allows the omni wheel to have more consistent characteristics and is less affected by contaminants such as sand, gravel or other objects that can impact rotation. The sleeve and bearing portions are separately molded allowing these parts to define the rotation and spacing characteristics.

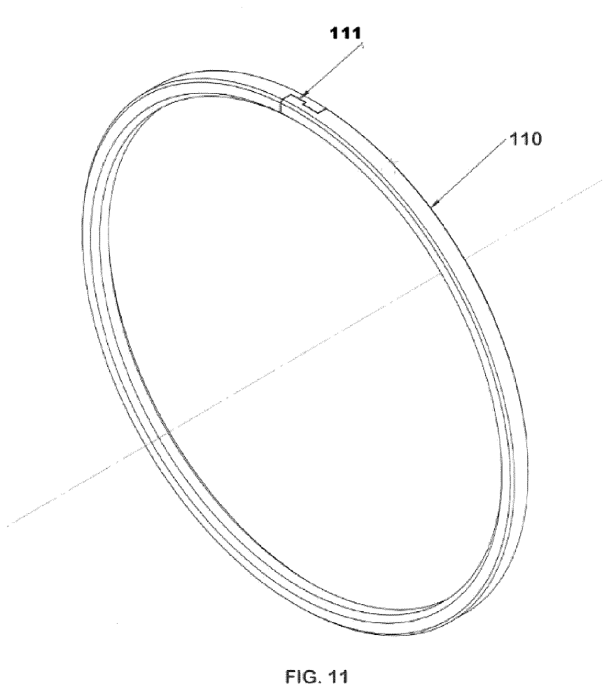

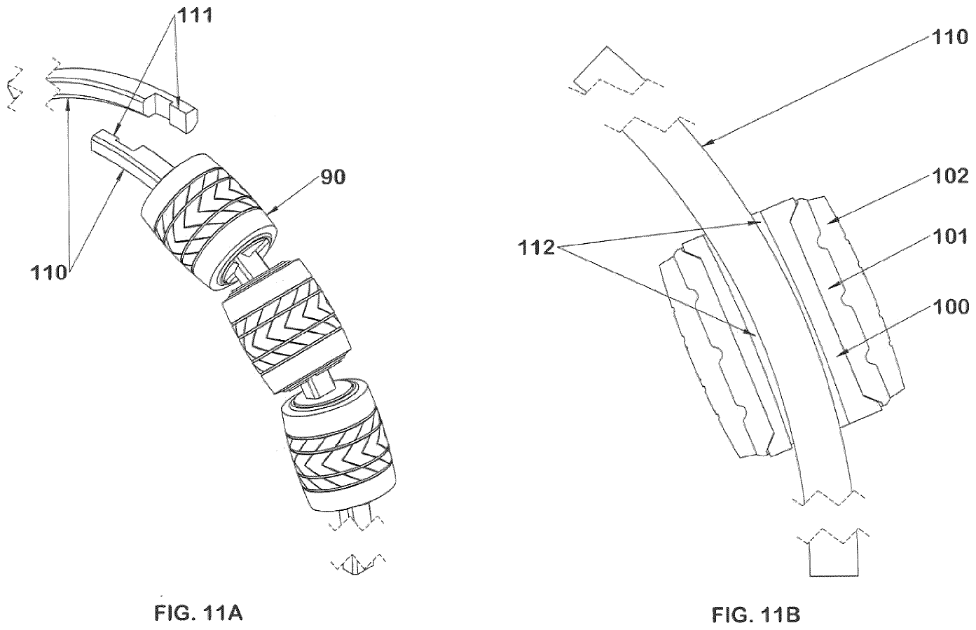

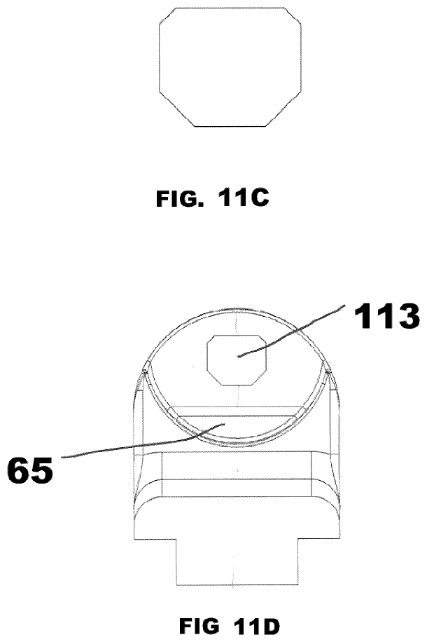

In order to properly assemble the omni-wheel 2, the individual roller wheels 30 are received on the continuous support 110. The continuous support 110, as shown in FIG. 11, includes a releasable joined section 111 (shown in FIG. 11A). The roller wheels are placed on the continuous support and the continuous support is joined by shifting of the roller wheels to create the necessary space for joining at 111 and then the roller wheels are slid around the continuous support such that one sleeve sits over the join at 111 and space between roller wheels is equally distributed around the continuous support to accept the width of the ribs. In this way, the individual roller wheels can be inserted on the continuous support 110 and the support joined before securement in the hubs. Once the roller wheels are placed on the continuous support and the continuous support is joined, the right and left hub sections can be aligned and connected. The roller wheels 30 are positioned in individual cells between the radially extending ribs 20. As evident from FIG. 11 and the sectional view of the continuous support 110 shown in FIG. 11C, the continuous support 110 has an irregular hexagonal type cross-section where the outer side is of a greater length than the opposing inner side of the continuous support. The particular type of shape of the continuous support is preferably non-circular to engage the sleeves 100 of each roller wheel in a non-rotatable manner. Each roller wheel then includes a bearing portion 101 exterior to the sleeve portion and the bearing portion freely rotates on the sleeve portion. The bearing portion includes an appropriate traction surface or traction cylinder 102 for engaging the support surface. With this arrangement, the roller wheel includes its own rotational components separate from the continuous support and close contact with the ribs is achieved.

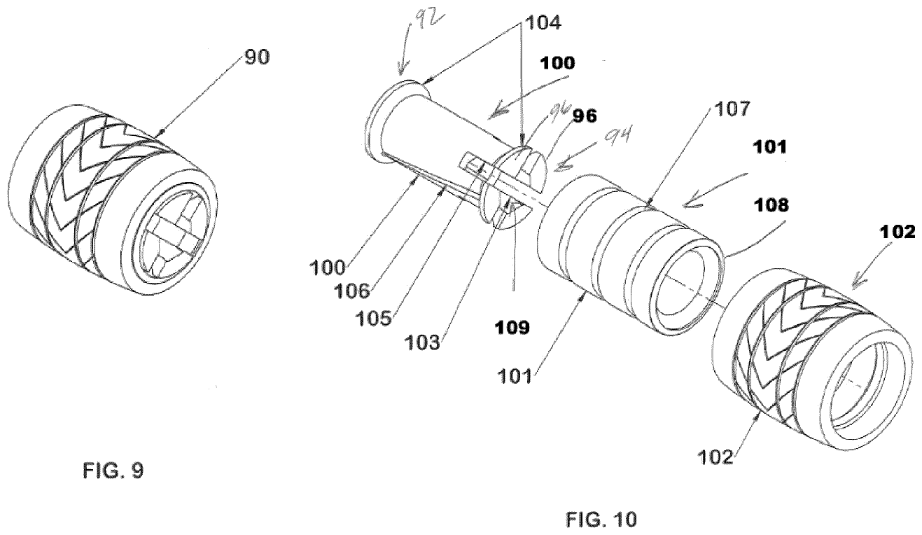

The particular structure of each roller wheel 30 is shown in FIGS. 9 and 10. FIG. 9 shows a perspective view of the assembled roller wheel. An exploded assembly view of the roller wheel is shown in FIG. 10. Each roller wheel 30 includes a sleeve member 100 having opposed collar segments 104. The collar segment 94 includes displaceable portions 96 that move inwardly to allow the bearing portion 101 to be inserted on the sleeve 100. Insertion of the bearing portion 101 on the sleeve 100 causes one end of the bearing 101 to abut with the collar segment 92. With the bearing 101 in abutment with the collar 92, the collar 94 clears and engages and retains the end 108 of the bearing. In this way, the bearing 101 is trapped between the two collars 92 and 94 and is free to rotate on the sleeve portion.

In an alternative embodiment, the sleeve 100 could be split into two halves (one with collar 92 and the other with collar 94) without displaceable portions 96, with each half simply slid into bearing portion 101 from each end and as a further alternative, sleeve 100 complete with collar segment 92 and 94 but without displaceable portions 96 can be 3D printed inside bearing 101 as bearing 101 is being 3D printed with systems such as the HP Jet Fusion or Selective Laser Sintering (SLS) where parts can be simultaneously printed in very close proximity, yet be free to rotate within or between each other. In all cases, the sleeve 100 maintains a fixed length so that collar segments 92 and 94 do not squeeze together (even while experiencing any deflection of the continuous support 110 or radially extending ribs) and thus do not inhibit the rotation of bearing 101. In FIG. 10, a traction cylinder 102 (suitable for ground engagement) is sleeved onto bearing 101 for fixed rotation therewith and can alternatively be over-molded onto bearing 101.

Ends of the traction cylinder 102 may also be reinforced or fully bonded with bearing 101 for operating environments where these normally softer roller edges must aggressively dig into rough uneven terrain typified in mining or combat zones. For large diameter hub applications, the present invention does not preclude bearing 101 from rotating around sleeve 100 on stainless steel or other ball bearings instead of relying on low-friction plastic or composite construction. Similarly, a stainless-steel bearing 101 can be fabricated to slide on a plastic or composite sleeve 100 where impacts resulting from high speed motion and heavier holonomic platforms would otherwise deform a plastic or composite bearing 101 resulting in unacceptably high friction losses. Sleeve 100 is designed such that it can incorporate one or more shallow channels 106 which direct any sand or other debris away from the rotating surfaces of sleeve 100 and bearing 101 as the omni-wheel rotates.

In FIG. 10, a traction cylinder 104 (suitable for ground engagement) is sleeved onto the bearing 98 for fixed rotation therewith. The traction cylinder 104 includes internal ribs 105 that fit in and engage slot recesses 107 in the molded sleeve 90. The traction cylinder 104 also includes interior cylindrical ribs 109 spaced in the traction cylinder and received in cylindrical recesses 111 in the molded sleeve 90.

The sleeve 100 includes a central socket or port 109 to be supported by and engaged with the continuous support 110. With omni-wheels in general, the force on any of the roller wheels 30 can be quite high and the present structure effectively distributes the force. For example, if the roller wheel happens to strike a rock or pebble during the rotation of the wheel, the inner cavity of the sleeve engages the continuous support 110 to distribute the load to the continuous support and distribute the load to not only the two immediately adjacent radially extending ribs but other adjacent ribs of the hub. The continuous support serves to distribute loads exerted on the individual roller wheels to a larger portion of the hub and to all of the immediately adjacent ribs. If this continuous support axle was not commonly shared, far higher stress in the ribs would occur. For extreme terrain cases, the continuous support can be fabricated without the ability to significantly deform which will no longer enable it to partially absorb physical shock, but instead will enable it to more effectively transfer the shock from one or more roller assemblies via their sleeves to all ribs. For example, if the holonomic vehicle falls with gravity and first lands on one omni-wheel and one roller assembly therein, the opposing force of the collision with the ground will be split between the lower-projecting and the upper-projecting ribs with the lower-projecting ribs experiencing compression and the upper-projecting ribs experiencing expansion forces. This distribution of kinetic force is vital to large autonomous systems equipped with omni-wheels which could be sized to 1.5 meters or more in diameter to overcome large terrain irregularities.

In some cases, depending on vibration reduction goals and fabrication materials and techniques available, it will be advantageous to mold the channel inside sleeve to a larger radius than the actual radius of the continuous support. Looking at FIG. 11B, the larger radius of the channel inside the sleeve 100 relative to the radius of the continuous support 110 creates gaps 112 which enable the roller wheel assembly 90 to slightly spring (in a manner similar to that of leaf springs), and rotate planar to the hub on the continuous support. The invention also allows for the outer collar ends of the sleeve to be slightly outwardly rounded with the corresponding inside of each rib adjoining the outer collar ends of the sleeve to be similarly rounded and the slight enlargement of port 113 in a direction parallel to that of the ribs. The introduction of these relatively subtle loosing of the sleeve in an orientation coplanar with the omni-wheel on the continuous support allows it to pivot slightly when first reaching the floor and also to have additional compliance when encountering uneven surfaces or sudden shock. By combining this motion with different traction cylinder profiles and traction cylinder material densities, vibrations transmitted via the omni-wheels during holonomic motion can be reduced for a given floor type and expected anomalies.

Once the continuous support has been inserted through the cavity in each individual roller wheel, it is no longer possible for the individual collar sections 96 to move inwardly in any significant manner. The presence of continuous support limits such inward motion and, thus, the now fixed collar portions function to prevent the bearing from moving sideways along the sleeve and contacting the ribs while distributing loads to the continuous support.

With the arrangement of the continuous support running through port 109 in the roller wheel assemblies being supported by the radially extending ribs through port 113, effective distribution of forces exerted on the wheel to the hub through the ribs is realized. The design also allows for effective rolling of each roller wheel in its particular cell within the hub. The collar segments serve as spacers allowing the bearing portion and the traction cylinder portion to roll on the sleeve portion out of contact with the ribs. The size of the bearing, i.e., the circular surface that acts to distribute the load to the sleeve portion, is larger than the circumference of the continuous support and is typically significantly larger than short steel axle sections used in conventional omni-wheels.

Conventional omni-wheels also suffer frequent roller axle failure if exposed to a brief unexpected physical shock such as a fall and hard landing on one roller. The present invention averts failure in such brief unexpected physical shocks. In the event of such heavier than intended loads, the roller in contact with the ground can move upwards into area 65 before being unable to move any further due to the adjoining ribs and hub. The wheel hub's design prevents any damage to the components under stress, since the continuous support can elastically deform with the ribs to nest the traction cylinder against the hub and will return to its initial position once the heavy load is relieved. Under such abnormally heavy load cases, the omni-wheel will still be able to rotate but be unable to move lateral to the wheel's plane of rotation since the rollers bearing the load will nest into area 65 and the traction cylinders will press against the hub cavity at each end. This will cause an undesirable perturbation in the overall vehicle's holonomic motion, but as soon as the omni-wheel rotates further or the load is reduced, the roller will rebound to its original position and full holonomic motion will be restored.

All parts of the design, including the right and left hub sections, can be cost effectively produced by injection molding in an accurate manner. The continuous support 110 can also be made of an injection molded plastic or nylon and may include reinforced plastic materials such as a graphite fiber reinforced plastic. With this arrangement, less variation due to tolerance and/or assembly inconsistencies is possible.

The components of the roller wheels, namely, the sleeve and the bearing, can be made of cooperating plastics to provide good durability, efficient rolling of the wheel and improved reliability.

The hub sections can include snap assembly tabs such that the entire omni-wheel assembly can be completed without screws or additional fasteners. Assembly (and disassembly for component maintenance and refurbishment) is easy and quick (and is also well suited to automation): Sleeves are snapped into bearings and the traction cylinder pressed over the bearing before each roller assembly is slid onto the continuous support which is then closed at the releasable joint and the rollers are then equally spaced around the circumference with one roller covering the releasable joint. The omni-wheel is completed by placing the continuous support/roller assembly into one-half of the wheel hub and the other half is snapped in place (hubs optionally glued together for extra durability).

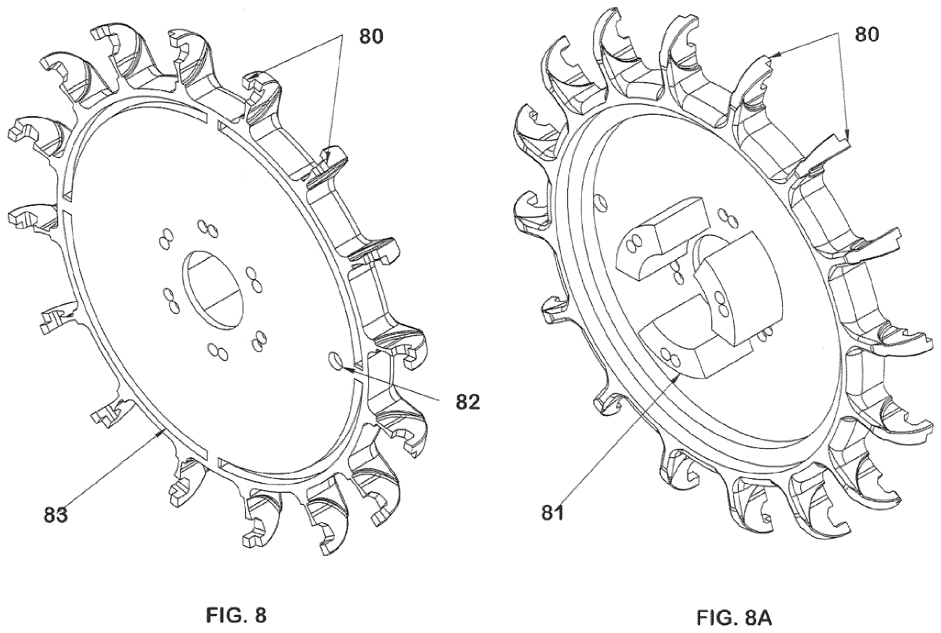

Now taking a closer look at 40 and 41 through FIGS. 7 to 8A, tabs 70 and 80 on wheel hub ribs 63 strengthen the ribs and provide resistance against torque. 70 and 80 on 40 and 41 respectively, are alternating and prevent separate rotation of 40 and 41. Lips 71 and grooves 83, of 40 and 41 respectively, also assist in providing resistance against torque. 71 and 83 also provide a larger surface area for preventing shearing between 40 and 41 (if there was no axle or bolts in place) versus the smaller areas of 70 and 80. Holes 72 and 82 merely provides a visual indicator on the wheel hub, such that a technician could more quickly indicate and find which roller assembly may need replacement.

As shown in FIGS. 12, 13 and 14, it is possible to join two omni-wheels to provide a double omni-wheel with the individual roller wheels appropriately shifted (offset) to cover the gap in the other wheel that occurs due to the position of the radially extending ribs. The current invention illustrates a hub design that enables the joining of two, three, four or more omni-wheels with one set of injection-molded hub rolling. By providing thin ribs and keeping the spacing between the individual roller wheels small, the peak forces exerted on the wheels can be distributed to the wheel hub reducing high stress load in individual ribs.

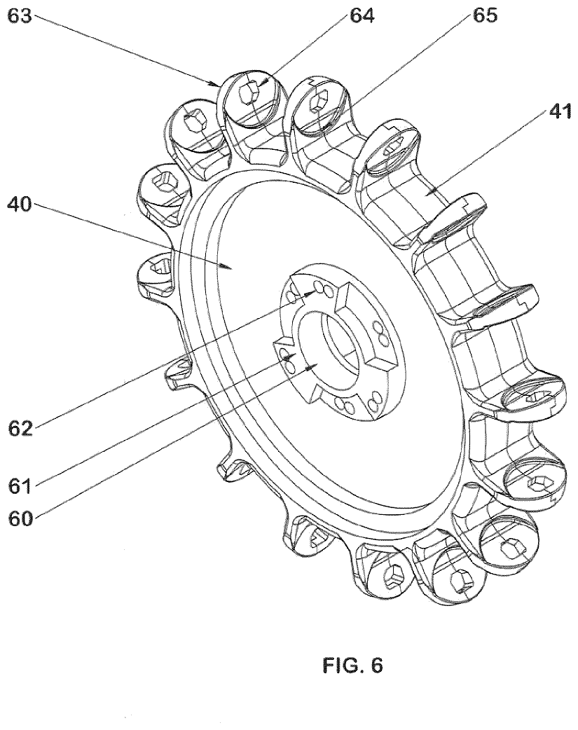

In the present embodiment, areas 61 of FIG. 6 and corresponding area 81 of FIG. 8A act as built-in spacers between the wheel hub and other components such as a hub cap or drive pulley. Having those areas as part of 40 and 41, allows fewer components of an overall assembly, and creates the proper spacing and orientation between adjacent omni-wheels (as seen in FIGS. 12 to 14). Although, a more general version of the omni-wheel may exist without those areas. Holes 62 are for bolts to secure 40 and 41 together, along with other components like a drive pulley or hub cap. In the present embodiment, although six bolts would be used, twelve holes are shown as ideal for double omni-wheels. Holes 62 are offset such that the adjacent wheel would have the optimal orientation for maximum ground contact. More holes could be added to add more adjacent wheels, only longer bolts would be needed. In all cases, instead of bolts, adhesives to join omni-wheels, hub caps, and drive pulleys or hub motors can be employed where these components will not later be serviced individually.

Although various preferred embodiments of the present invention have been described herein in detail, it will be appreciated by those skilled in the art that variations may be made thereto without departing from the appended claims including integral hub motors, active suspension hub designs and composite, cast or other fabrication techniques which might vary based on parameters such as size or operating envelopes of holonomic platforms.

Furthermore, although ultra-high-molecular-weight polyethylene (UHMWPE) is the most likely commonly available material for bearing and sleeve injection molding in smaller diameter applications, to provide low friction, self-lubrication, resistance to corrosion and abrasion, low moisture absorption, and high impact strength, many other materials including nylon, carbon fiber, and metal are applicable to the present design depending on target use applications. Although the left and right hub sections are designed to be easily injection-molded, a one-piece hub with a smaller half-spoke ring is also anticipated with this invention as is the 3D printing of the entire invention in one pass with printers such as the HP Jet Fusion or Selective Laser Sintering (SLS), assuming low-friction material availability. In this case, those skilled in the art can clearly see that there would be no need for two halves to the hub, nor joins in the ribs or in the continuous member and other simplifications including multiple connected parallel omni wheel setups from one print job are clear from the present invention. Where multi-material options are not available during 3D print operation, the traction cylinder 102 and relating tread design could be integrated into the outer shape of the bearing 101 and then painted or rolled rubber or similar material applied to the outer part of this hybrid traction cylinder/bearing after 3D printing where surface traction dictated.

And furthermore, in cases where Jet Fusion or SLS material costs are high relative to a need for shock resistance, in a variation of the present invention, wheel cells 50 can be deprecated and significantly deepened into the hub and ribs 20 can be seamlessly combined with the continuous support 110 and the sleeve portion 100 for HP Jet Fusion or SLS printing of the omni-wheel in one piece with the only fine gap between the sleeve and the rotatable bearing portion. In this case, the integrity of the combined ribs, continuous support and sleeve enables significant elongation of the ribs and corresponding reduction of the hub volume while maintaining the overall omni-wheel diameter. Given sufficiently resilient Jet Fusion or SLS material, the ribs themselves can be thinned and the rib material at the circumferential inner point at area 65 where wheel rollers get closest together could be entirely eliminated (the ribs would now fork around such inner point to then be directly attached to the now hybrid continuous support and sleeve, enabling the roller wheels to be slightly elongated to the point where they almost touch together at area 65).

A further variation of the present invention includes that in all cases where the omni-wheel operates in areas exposing it to sand or other small abrasive partials, one or more shallow channels 106 will be incorporated into the sleeve or bearing to direct any such debris away from the rotating surfaces of sleeve 100 and bearing 101 as the omni-wheel rotates.

The embodiments of the invention in which an exclusive property or privilege is claimed are defined as follows:

1. An omni-wheel comprising central hub with a center port for receiving a wheel axle and a series of spaced apart radially extending ribs at a periphery of said central hub; said spaced apart radially extending ribs defining wheel cells between adjacent ribs of said spaced apart radially extending ribs with a continuous support spanning said wheel cells;
said continuous support engaging support sockets of said spaced apart radially extending ribs and receiving a roller wheel within each wheel cell;
each roller wheel including a sleeve member received on said continuous support and a cooperating rotatable bearing about and rotatably supported by said sleeve member, said sleeve member including an axially extending support cavity having said continuous support extending there through.

2. An omni-wheel as claimed in claim 1 wherein said continuous support forms a single support for each and every roller wheel.

3. An omni-wheel as claimed in claim 2 each of said sleeve members and said cooperating bearings are made of an injection moldable plastic or otherwise deformable material.

4. An omni-wheel as claimed in claim 2 wherein said continuous support includes at least one joint connection allowing insertion of said roller wheels on said continuous support.

5. An omni-wheel as claimed in claim 4 wherein said sleeve members engage said continuous support forming a non-rotatable connection about said continuous support.

6. An omni-wheel as claimed in claim 5 wherein each sleeve member includes a central cylinder portion with opposed outwardly extending locking collars either end of said cylinder portion; and wherein one end of the sleeve member includes inwardly deflectable fingers movable between a non-deflected and a deflected position, said deflectable fingers in said deflected position allowing the locking collar at the end thereof to deflect inwardly sufficiently allowing said rotatable bearing to be inserted on said cylinder portion and said deflectable fingers when in said non deflected position positioning said locking collar to retain said rotatable bearing on said cylinder portion.
